(19) United States
(12) Patent Application Publication
(10) Pub. No.: US 2004/0133476 A1
(43) Pub. Date: Jul. 8, 2004

(54) Unmanned lodging house device and method for providing check-in/out services using the device

(75) Inventor: Jae-Hyoung Kim, Anyang-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/459,945

(22) Filed: Jun. 12, 2003

(30) Foreign Application Priority Data
Jan. 2, 2003 (KR) 142/2003

(51) Int. Cl. G06F 17/60

(52) U.S. Cl. 705/18

(57) ABSTRACT

An unmanned lodging house device, which combines a payment system based on a mobile communication terminal with an electronic door lock unit, and a method for providing check in/out services using the unmanned lodging house device, and a computer-readable recording medium stored with a program for implementing the same method. The unmanned lodging house device includes a card reader, a door lock, a room status display, a user interface, and a controller. The controller receives a payment approval information and a room secret number through the card reader, and sets the received room secret number as a secret number of the door lock after the user confirms the received room secret number through the user interface, and further enables the room status display unit to display the room status when the setting of the secret number of the door lock is completed.

### PRIORITY

This application claims priority to an application entitled “UNMANNED LODGING HOUSE DEVICE AND METHOD FOR PROVIDING CHECK IN/OUT SERVICES USING THE SAME DEVICE”, filed in the Korean Industrial Property Office on Jan. 2, 2003 and assigned Serial No. 2003-00142, the contents of which are hereby incorporated by reference.

### BACKGROUND OF THE INVENTION

1. Field of the Invention

The present invention relates generally to an unmanned lodging house device, and more particularly to an unmanned lodging house device whereby customers can use all services and facilities in a lodging house in an unmanned manner.

2. Description of the Related Art

An unmanned lodging house device of the prior art generally uses a micro-payment system in which a mobile communication terminal is used for paying the charges. Such an unmanned lodging house device also uses an electronic door lock device for locking a door of a lodging room and releasing the lock in response to a correctly input secret number. However, there is no technique for enabling cooperation between the micro-payment system and the electronic door lock device.

FIG. 1 illustrates a configuration of the micro-payment system of the prior art that uses the mobile communication terminal. As illustrated in FIG. 1, the micro-payment system includes a mobile communication terminal 11, a card reader (or CAT: Credit Authorization Terminal) 12, a VAN (Value Added Network) 13, an affiliated company 15, and a mobile communication company 16. The card reader 12 reads settlement information from the mobile communication terminal 11 for requesting an approval for the settlement. The VAN 13 transmits the settlement information of the terminal 11 to a credit card company 14, and transmits information on the settlement's approval to the card reader 12 and the affiliated company 15. The affiliated company 15 transmits the settlement approval information, received from the VAN 13, to the mobile communication company 16. This company 16 transmits the settlement approval information received from the affiliated company 15 to the mobile communication terminal 11.

The operation of the micro-payment system is described in detail as follows. Upon receipt of a request for a micro payment from the mobile communication terminal 11 (101), the card reader 12 requests the VAN 13 to approve the requested micro payment (102). The VAN 13 requests the credit card company 14 to approve the micro payment (103), receives information on an approval for the micro payment, as a response, from the company 14 (104), and then transmits the received approval information to the card reader 12 and the affiliated company 15 (105, 106). The affiliated company 15 transmits the micro-payment approval information to the mobile communication company 16 (107). The mobile communication company 16 transmits the approval information to the mobile communication terminal 11 (108), thereby finishing the procedure of performing the micro payment using the mobile communication terminal.

Such a micro-payment service by itself is not very effective in providing unmanned services such as unmanned lodging house services. For example, it will be necessary for the unmanned lodging house to receive a key for releasing the lock of a door lock device in each of lodging rooms. As described above, the unmanned lodging house device of the prior art can transact the payment of charges in an unmanned manner, but there is still no method for providing a service of receiving the corresponding key in an unmanned manner. In addition, the lodging house device of the prior art provides no method for changing the staying period of the customer in an unmanned manner.

### SUMMARY OF THE INVENTION

Therefore, the present invention has been designed in view of the above problem, and it is an object of the present invention to provide an unmanned lodging house device which combines a payment system based on a mobile communication terminal with an electronic door lock device which releases the lock of a door by a correctly input secret number, and provides a method for providing check in/out services using the same unmanned lodging house device, and further provides a computer-readable recording medium stored with a program for implementing the same method.

It is another object of the present invention to provide an unmanned lodging house system, which replaces a conventional lodging house system requiring manual payment of charges and management of keys, so as to achieve a reduction of personnel expenses, a protection of the privacy of customers, and an effective lodging house management.

In accordance with one aspect of the present invention, the above and other objects can be accomplished by an unmanned lodging house device comprising: a card reader for receiving payment information from a user and transmitting the received payment information to a VAN, receiving information on an approval of the payment and a room secret number from the VAN, and transmitting the received information; a door lock unit to which a secret number is set and which enables a room door to be opened when a user inputs the set secret number to the door lock unit; a room status display unit for displaying information on a current room status on a room status display bulletin board provided on an exterior of the display unit; a user interface unit including a display window and a keypad for providing the user with information containing the room status information and receiving the user's input of the secret number of the room and a lodging schedule; and a controller for receiving the approval information and the room secret number through the card reader, and setting the received room secret number as a secret number of the door lock unit after the received room secret number is confirmed by the user through the user interface.

In accordance with another aspect of the present invention, there is provided a method for providing check-in services using an unmanned lodging house device, the method comprising: receiving a lodging schedule input by a user; outputting information on charges of the lodging schedule; receiving a request for payment of the charges from the user; requesting a VAN to approve the payment; upon receipt of an approval to the approval request, requesting the user to confirm a secret number assigned by the VAN; and when the secret number is confirmed, setting the secret number as a secret number of a door lock unit.

In accordance with yet another aspect of the present invention, there is provided a method for providing check-out services using an unmanned lodging house device, the method comprising: receiving an input for a check-out request from a user; checking whether the requested check-out date is the same as a previously-set check-out date; if the check-out date is the same as the previously-set check-out date, performing a normal check-out process and displaying room status information indicating a vacant room; and if the check-out date is not the same as the previously-set check-out date, changing a lodging schedule.

### BRIEF DESCRIPTION OF THE DRAWINGS

The above and other objects, features, and advantages of the present invention will be more clearly understood from the following detailed description taken in conjunction with the accompanying drawings, in which:

FIG. 1 illustrates a configuration of a conventional micro-payment system that uses the mobile communication terminal;

FIG. 2 illustrates a configuration of an unmanned lodging house device for performing a micro payment process according to an embodiment of the present invention;

FIG. 3 illustrates configuration of an unmanned lodging house system that employs the unmanned lodging house device capable of transacting a micro payment, according to the embodiment of the present invention;

FIG. 4 illustrates a payment procedure in the unmanned lodging house system that employs the unmanned lodging house device of FIG. 3 according to the present invention;

FIG. 5 illustrates a procedure of providing unmanned services to a user using an unmanned lodging house device according to the present invention;

FIG. 6 illustrates a procedure of providing check-in services using the unmanned lodging house device according to the present invention; and

FIG. 7 illustrates a procedure of providing check-out services using the unmanned lodging house device according to the embodiment of the present invention.

### DETAILED DESCRIPTION OF THE PREFERRED EMBODIMENTS

Preferred embodiments of the present invention will be described in detail herein below with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

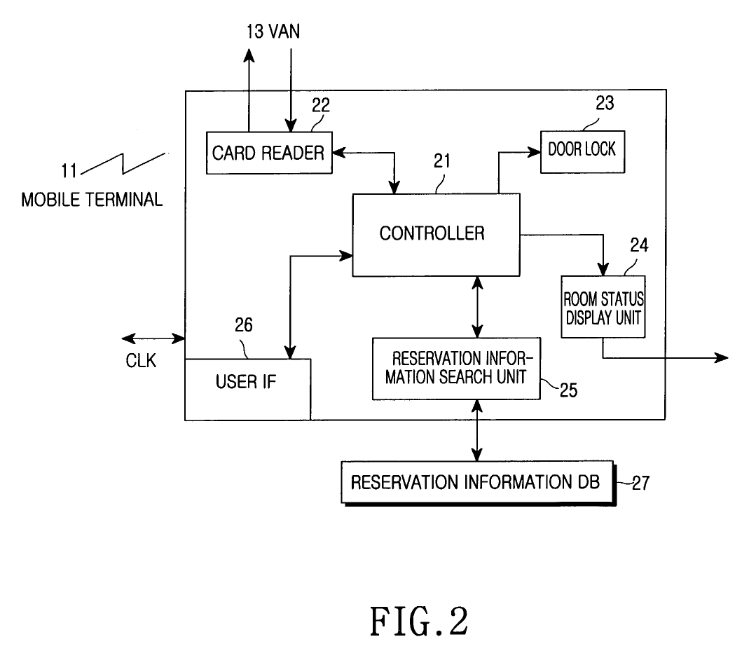

FIG. 2 illustrates a configuration of an unmanned lodging house device for performing a micro payment process according to an embodiment of the present invention. As illustrated in FIG. 2, the unmanned lodging house device includes a card reader 22, a door lock unit 23, a room-status display unit 24, a reservation information search unit 25, a user interface (User IF) 26, and a controller 21. The card reader 22 receives payment information from a mobile communication terminal 11 and transmits it to a VAN 13. In addition, the card reader 22 receives information such as an approval for the payment from the VAN 13 and transmits it to the controller 21. A secret number is set to the door lock unit 23 under the control of the controller 21, and the door lock unit 23 releases the lock of a corresponding door when the secret number is correctly input. The room-status display unit 24 displays a current room status on a room-status display bulletin board mounted thereon, under the control of the controller 21. The reservation-information search unit 25 is used for retrieving reservation information on a room for the purpose of registering or modifying a lodging schedule of the room. The user interface 26 includes a display window to provide users with information such as a room status and various advertisement information. The interface 26 also includes a keypad for enabling users to input a secret number and a desired lodging schedule. The controller 21 controls the overall operation of the above constituents.

In more detail, the controller 21 controls a door-lock setting function, a room-status display function, and a reservation checking function. In performing the door-lock setting function, the controller 21 receives a secret number together with the payment approval information of a corresponding room from the card reader 22, and sets the received secret number as a secret number of the door lock unit 23 after the secret number is confirmed through the user IF 26. In performing the room-status display function, the controller 21 controls the room-status display unit 24 to display the room status when the setting for the door lock unit 23 is completed. In performing the reservation checking function, the controller 21 searches a reservation information database 27 to retrieve and display the reservation information of the room in response to a user's request.

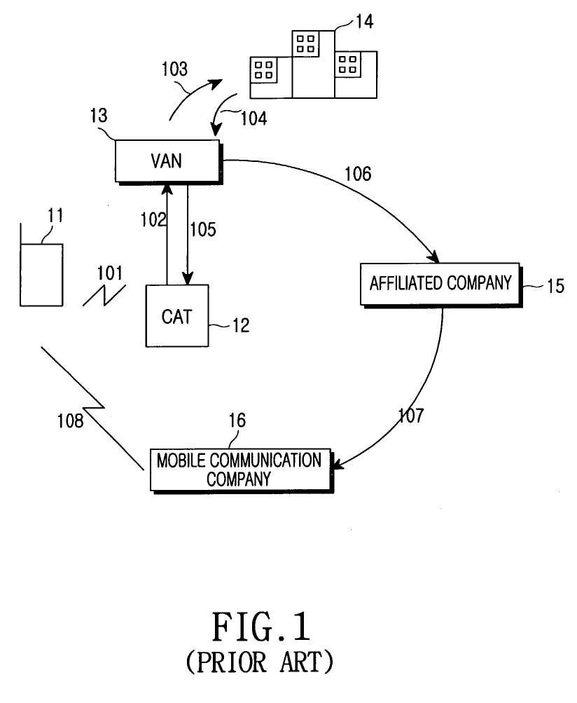

According to the present invention, the unmanned lodging house device may use the same micro payment system of the prior art as illustrated in FIG. 1, but combines the card reader with the door lock unit. Therefore, it is possible to utilize the existing hardware for the payment system without increasing the system cost.

The above description has been given as an example with reference to the micro payment system using the mobile communication terminal, but the present invention may also employ a micro payment system using a credit card as payment means. In this case, the last four digits of the card number or a secret number of the credit card can be set to a secret number for releasing the door lock.

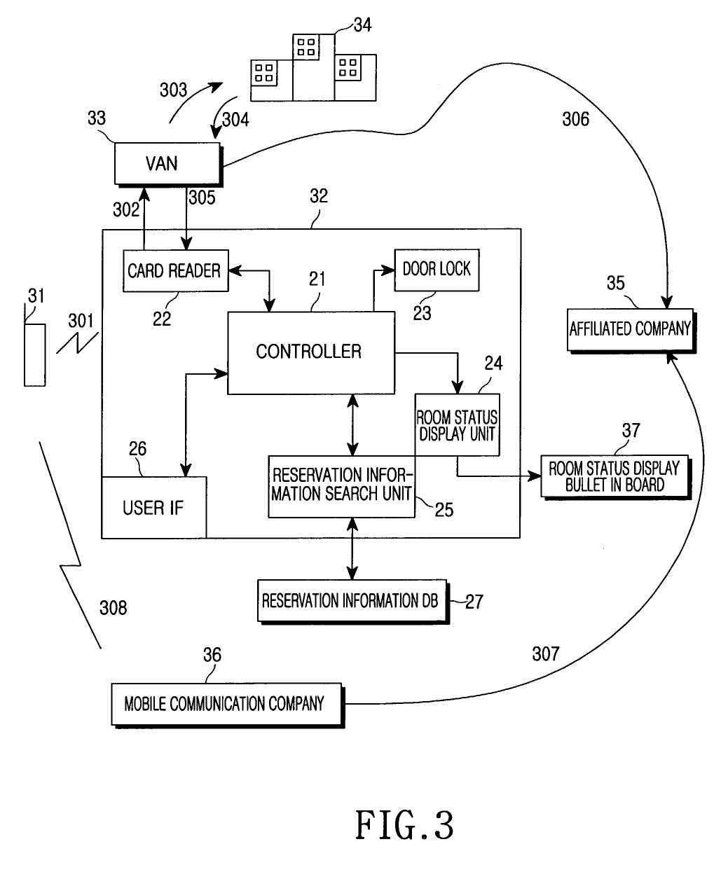

FIG. 3 illustrates a configuration of an unmanned lodging house system that employs the unmanned lodging house device capable of transacting a micro payment, according to the embodiment of the present invention in FIG. 3, the payment system using the mobile communication terminal according to the present invention is similar to that of FIG. 1. Specifically, when a user requests the card reader 22 for payment of charges using a mobile communication terminal 31 (301), the card reader 22 requests the VAN 33 to approve the requested payment (302). The VAN 33 requests the credit card company 34 in charge of loan business matters to approve the payment (303). When the VAN 33 receives information on an approval for the payment from the credit card company 34 (304), the VAN 33 transmits the approval information and the payment information to the card reader 22 and the affiliated company 35 (305, 306). The approval information transmitted to the card reader 22 contains information on a secret number.

The affiliated company 35 transmits the corresponding issuance details to the mobile communication company 36 (307) to enable the terminal's user to confirm the payment information (308).

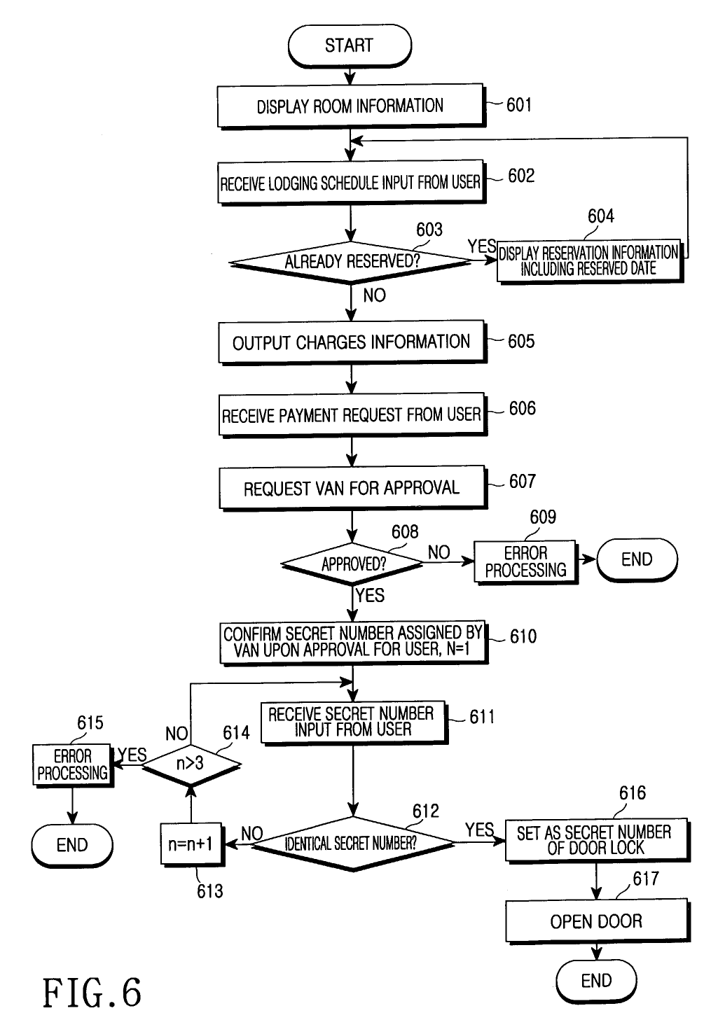

The secret number information contained in signals in step (305) is transmitted to the controller 21 from the card reader 22. The controller 21 confirms a secret number input by a user through the user interface 26. This secret number confirming process is described later in detail referring to FIG. 6.

When it is confirmed that the secret number input by the user through the user interface 26 is identical with the secret number contained in the approval information, the controller 21 sets the confirmed secret number as a secret number of the door lock unit 23, and then displays a room status message “In Use” on the room status display bulletin board 37 coupled to the room status display unit 24. The room status message “In Use” is changed to “Vacant” when the user checks out.

The reservation information search unit 25 retrieves information on a reservation schedule (e.g., a reserved period) of the corresponding room from the reservation information database 27 according to a user's request, and then provides the retrieved information to the user through the user interface 26.

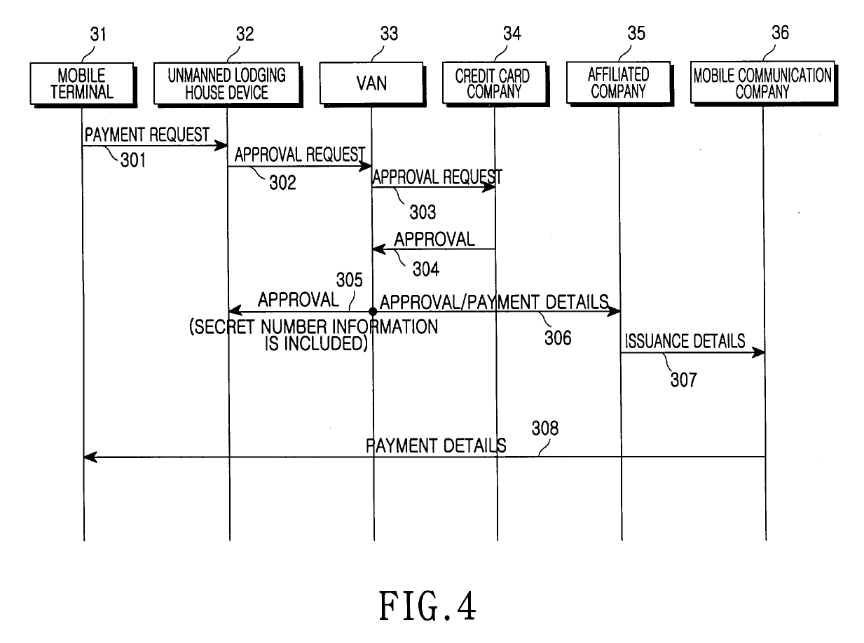

FIG. 4 illustrates a payment procedure in the unmanned lodging house system that employs the unmanned lodging house device capable of transacting a micro payment, according to the present invention. As illustrated in FIG. 4, when a user operates a mobile communication terminal 31 to request the unmanned lodging house device 32 for payment of charges (301), the unmanned lodging house device 32 requests the VAN 33 to approve the requested payment (302). The VAN 33 requests the credit card company 34 in charge of loan business matters to approve the payment (303). When the VAN 33 receives information on an approval for the payment from the credit card company 34 (304), the VAN 33 transmits the approval information and the payment information to the unmanned lodging house device 32 and the affiliated company 35 (305, 306). The approval information transmitted to the unmanned lodging house device 32 contains information on the secret number.

The affiliated company 35 transmits the corresponding issuance details to the mobile communication company 36 (307) to enable the user of the mobile communication terminal to confirm the payment information (308).

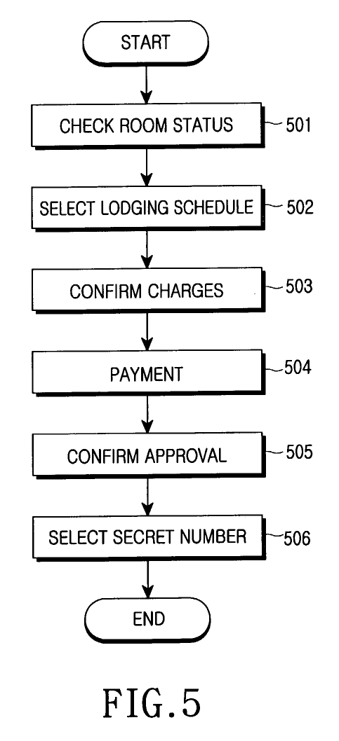

FIG. 5 illustrates a procedure of providing unmanned services to a user using the unmanned lodging house device according to the present invention. In FIG. 5, to use the unmanned lodging house device, a user first checks the room status of each of rooms through each room status display bulletin board in step 501. Each room-status display bulletin board displays the room status of a corresponding room, one of “In Use” and “Vacant”, through its electric signboard or bulletin board section, and then the user selects one of rooms on which “Vacant” is displayed. Then, the user confirms the corresponding reservation information through the reservation information search operation, and selects a desired lodging schedule in step 502. And then, the user confirms the charge for the selected schedule in step 503. Subsequently, the user performs the payment process using the mobile communication terminal in step 504.

Next, the user confirms an approval of the payment in step 505, and then inputs a secret number composed of, for example, the user's personal information in step 506. When the secret number is correctly input, the input secret number is set as a secret number of the corresponding room, so that the user can use the room for the staying period with the set secret number.

FIG. 6 illustrates a procedure of providing check-in services using the unmanned lodging house device according to the present invention. In FIG. 6, the unmanned lodging house device according to the present invention displays information of the current status of a room to the user in step 601. The user inputs a desired lodging schedule of the room through the user interface in step 602. The user checks whether there is an existing reservation whose lodging period overlaps with the input lodging period in step 603. If there is an existing reservation whose lodging period overlaps with the input lodging period, information on the existing reservation including its reserved date is displayed in step 604, and then the user inputs a new lodging schedule in step 602.

Otherwise, when there is no existing reservation whose lodging period overlaps with the input lodging period, information on the charges on the input lodging period is displayed in step 605, prompting the user to pay the charges. The unmanned lodging house device receives a payment request from the user in step 606, and requests the VAN to approve the payment in step 607.

When the approval fails, the unmanned lodging house device performs an error process corresponding to this approval failure in step 609.

When the payment is approved, the unmanned lodging house device is assigned a secret number from the VAN when the approval is made, and a confirmation of the assigned secret number is made with respect to the user in step 610. The number of times “n” for trying the secret number confirmation is initially set to ‘1’.

When the user inputs a secret number in step 611, it is checked whether the input secret number is identical with to secret number assigned from the VAN in step 612. If the input secret number is not identical to the secret number assigned from the VAN, the number of times “n” is increased by 1 in step 613, and it is checked whether the current value of “n” is larger than 3 in step 614. If the value of “n” is larger than 3, the device performs an error process whereby it transmits an error message indicating the non-identical secret number, and requests the VAN to cancel the approval in step 615. If the checked result of step in step 614 is that the value of “n” is not larger than 3, the procedure moves to step in step 611 to receive a new input of a secret number from the user in step 611. The total number of times for trying the secret number confirmation is not limited to 3, but can be freely set according to desires of the operator of the unmanned lodging house device.

If the checked result of step in step 612 is that both secret numbers are identical, the input secret number is set to a secret number of the door lock unit in step 616, and thereafter the user can use the secret number for using the corresponding room. Namely, after the secret number is set for the door lock unit in step 616, the user can open the door of the room by inputting the set secret number in step 617.

In the embodiment of the present invention, the secret number transmitted from the VAN is, for example, the last four digits of the terminal's secret number, the phone number, or the social security number of the user. In the embodiment of the present invention, the secret number confirmation process is performed in such a manner that the user is asked about one of such last four digits.

As described above, after the secret number is set to the door lock unit in step 616, the secret number is used as a secret number for using the corresponding room, and a message “In Use” is displayed on the room status display bulletin board for displaying all room states.

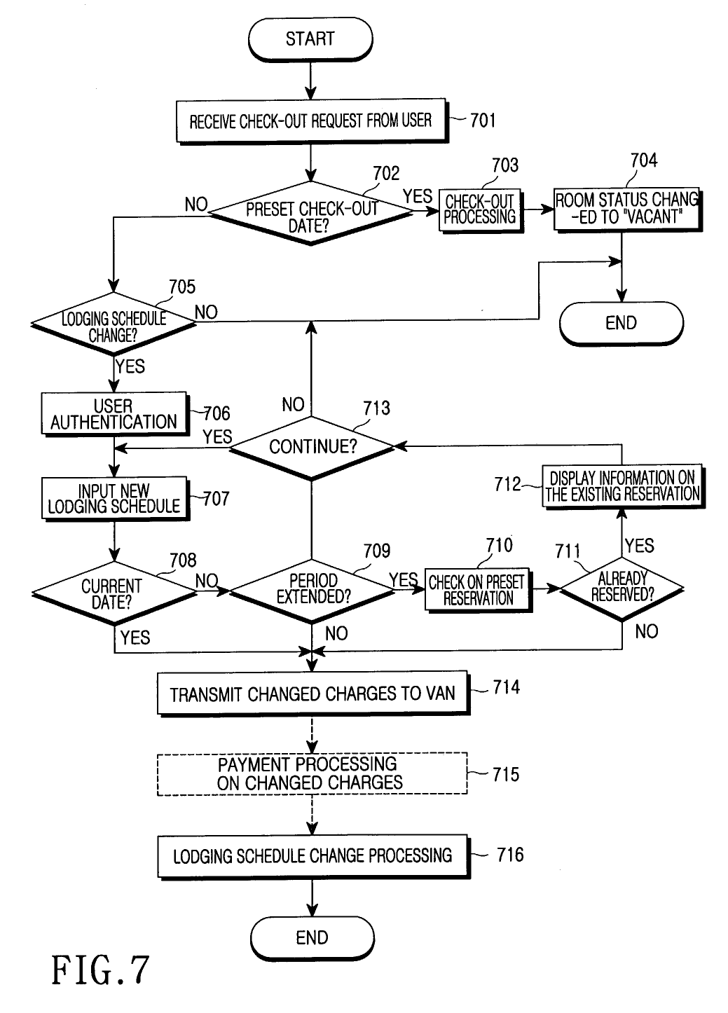

FIG. 7 illustrates a procedure of providing check-out services using the unmanned lodging house device according to the embodiment of the present invention. In FIG. 7, the unmanned lodging house device receives an input for requesting a check-out from a user in step 701. It is determined whether the requested check-out date is the same as the previously-set check-out date (e.g., a check-out date set at a check-in time) in step 702. When the requested check-out date is the same as the previously-set check-out date, the unmanned lodging house device performs a check-out process in step 703, and displays a room status message “Vacant” on the room status display bulletin board in step 704. When the requested check-out date is not the same as the previously-set check-out date in step 702, it is checked whether the input is to change the lodging schedule in step 705. When the input is not to change the lodging schedule, the input is regarded as a wrong input, and the corresponding procedure is ended. When the input is to change the lodging schedule, an authentication of the user is performed in step 706 in such a manner that the user is prompted to input the set secret number again.

The user requests a lodging schedule change while inputting a lodging schedule for replacing the existing lodging schedule in step 707. It is checked whether this input lodging schedule is set to check out on the current date in step 708. If the input lodging schedule is not set to check out on the current date, it is checked whether the input lodging schedule is set to extend the lodging period in step 709. When the input lodging schedule is set to extend the lodging period, it is checked whether the corresponding room has an existing reservation whose lodging period overlaps with the extended lodging period in step 710. When the corresponding room has an existing reservation whose lodging period overlaps with the extended lodging period, information on the existing reservation is displayed in step 712. Then, it is checked whether the user wants to continue the lodging schedule change process in step 713. When the user does not want to continue the lodging schedule change process, the corresponding procedure is immediately finished, and when the user wants to continue the lodging schedule change process, the procedure returns to step in step 707.

If the input lodging schedule is set to check out on the current date or to shorten the lodging period, or if the input lodging schedule is set to extend the lodging period and there is no existing reservation, charges to be paid are changed and then information on the changed charges is transmitted to the VAN in step 714, so that a payment process for the changed charges is performed in step 715. When the payment process is finished, the lodging schedule change is set to the corresponding room in step 716.

As is apparent from the above description, the present invention provides a service for payment of lodging charges and a service for receiving a secret number in an unmanned manner, so that personnel expenses for lodging facilities can be reduced and the lodging facilities can be effectively utilized.

In addition, the present invention has advantages in that the privacy of customers can be protected in providing unmanned services, and it is possible to extend the range of transactions available using the payment system using the mobile communication terminal.

Further, the present invention has an advantage in that a user can change the period of using the corresponding lodging facility using the unmanned lodging house device, thereby increasing the user's convenience in using the lodging facility.

The above-described methods for providing services in the unmanned lodging house can be embodied as a computer program and then stored in a computer-readable recording medium such as a CD-ROM, a RAM, a floppy disk, a hard disk, or an optical magnetic disk.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An unmanned lodging house device comprising:
a card reader for receiving payment information from a user and transmitting the received payment information to a value added network (VAN), receiving information on an approval of the payment and a room secret number from the VAN, and transmitting the received information;
a door lock unit to which a secret number is set, thereby enabling a room door to be opened when a user inputs the set secret number to the door lock unit;
a room status display unit for displaying information on a current room status;
a user interface unit for providing the user with information including the room status information and receiving the user's input of the secret number and a lodging schedule; and
a controller for receiving the approval information and the room secret number from the card reader, and setting the received room secret number as a secret number of the door lock unit after the received room secret number is confirmed by the user through the user interface.

2. The unmanned lodging house device as set forth in claim 1, further comprising a reservation information search unit for retrieving reservation information on the room for registering a lodging schedule of the room, wherein the controller searches a reservation information database for the room reservation information according to the user's request.

3. The unmanned lodging house device as set forth in claim 1, wherein the information provided from the user interface unit contains advertisement information.

4. The unmanned lodging house device as set forth in claim 1, wherein a mobile-communication-based micro payment system is used to input the payment information to the card reader.

5. The unmanned lodging house device as set forth in claim 4, wherein the secret number transmitted from the VAN is one of last four digits of a phone number, last four digits of a social security number, a secret number of a credit card, and last four digits of a credit card number.

6. The unmanned lodging house device as set forth in claim 1, wherein a credit card is used to input the payment information to the card reader.

7. The unmanned lodging house device as set forth in claim 6, wherein the secret number transmitted from the VAN is one of last four digits of a phone number, last four digits of a social security number, a secret number of a credit card, and last four digits of a credit card number.

8. A method for providing check-in services using an unmanned lodging house device, the method comprising:
receiving a lodging schedule input by a user;
outputting information on charges of the lodging schedule;
receiving a request for payment of the charges from the user;
requesting a value added network (VAN) to approve the payment;
upon receipt of an approval the approval request, requesting the user to confirm a secret number assigned by the VAN; and
when the secret number is confirmed, setting the secret number as a secret number of a door lock unit, thereby enabling the user to unlock the door lock unit using the secret number.

9. The method as set forth in claim 8, further comprising repeating the step of confirming the secret number a predetermined number of times when the secret number assigned is not confirmed.

10. The method as set forth in claim 8, wherein receiving the input of the lodging schedule from the user step comprises:
checking whether there is an existing overlapping reservation;
if there is an existing reservation, displaying information on the existing overlapping reservation and its reserved date, and receiving a new lodging schedule from the user; and
if there is no overlapping existing reservation, outputting the information on the charges of the lodging schedule.

11. The method as set forth in claim 8, further comprising changing a room status message displayed on a room status display unit to a message “In Use”, after setting a secret number as the secret number of the door lock unit.

12. The method as set forth in claim 8, wherein the secret number is one of last four digits of a phone number, last four digits of a social security number, last four digits of a secret number of a mobile communication terminal, a secret number of a credit card, and last four digits of a credit card number.

13. A method for providing check-out services using an unmanned lodging house device, the method comprising:
receiving a check-out request from a user;
checking whether the requested check-out date is the same as a previously-set check-out date;
if the requested check-out date is the same as the previously-set check-out date, performing a normal check-out process and displaying room status information indicating a vacant room; and
if the requested check-out date is not the same as the previously-set check-out date, changing a lodging schedule.

14. The method as set forth in claim 13, wherein changing the lodging schedule comprises:
checking whether an instruction to change the lodging schedule is received;
if the instruction to change the lodging schedule is received, performing an authentication of the user;
after performing the user authentication, receiving an input of a new lodging schedule to replace the existing lodging schedule;
requesting a payment of new charges according to the new lodging schedule;
receiving an approval in response to a payment of the new charges; and
setting the new lodging schedule.

15. The method as set forth in claim 14, wherein the user authentication is performed by the user inputting a secret number set at a check-in time.

16. A computer-readable recording medium for allowing an unmanned lodging house system including a processor to implement:
a first function of receiving a lodging schedule input by a user and outputting information on charges of the lodging schedule, and then receiving a request for payment of the charges from the user and requesting a VAN to approve the payment; and
a second function of, upon receipt of an approval as a response to the approval request, requesting the user to confirm a secret number assigned by the VAN when the approval is made, and, when the secret number is confirmed, setting the secret number as a secret number of a door lock unit.

17. A computer-readable recording medium for allowing an unmanned lodging house system including a processor to implement:
a first function of receiving an input for a check-out request from a user and checking whether the requested check-out date is the same as a previously-set check-out date;
a second function of, if the checked result by the first function is affirmative, performing a normal check-out process and displaying room status information indicating a vacant room; and
a third function of, if the checked result by the first function is not affirmative, performing a process for changing a lodging schedule.
